(19) United States
(12) Patent Application Publication
(10) Pub. No.: US 2008/0043208 A1
(43) Pub. Date: Feb. 21, 2008

(54) Projection system and its optical shutter

(75) Inventor: Chii-How Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/882,996

(22) Filed: Aug. 8, 2007

(30) Foreign Application Priority Data
Aug. 17, 2006 (TW) 095130271

(51) Int. Cl. G03B 21/14; G02B 26/02

(52) U.S. Cl. 353/88; 359/230

(57) ABSTRACT

An optical shutter for a projection system includes a shutter element and an actuator. The shutter element includes a light-shielding portion and a linkage portion. The light-shielding portion is disposed on the optical pathway of the projection system and is connected with the linkage portion. The light-shielding portion is bent toward the linkage portion and there is a pre-determined angle formed between the light-shielding portion and the linkage portion. The light-shielding portion faces the linkage portion with a predetermined angle. The actuator is coupled with the linkage portion to drive the shutter to swing.

### CROSS REFERENCE TO RELATED APPLICATIONS

This Non-provisional application claims priority under 35 U.S.C. §119(a) on Patent Application No(s). 095130271 filed in Taiwan, Republic of China on Aug. 17, 2006, the entire contents of which are hereby incorporated by reference.

### BACKGROUND OF THE INVENTION

1. Field of Invention

The invention relates to a shutter and in particular, to an optical shutter for a projection system and the projection system thereof.

2. Related Art

The image projection system is one of the most popular fields in the opto-electrical industry. To satisfy the market needs, modern projection systems have the trends of having large display areas, compact volumes, and light weights.

As shown in FIG. 1, the conventional projection system 1 includes a light source 10, a color wheel 11, an optical channel 12, a lens set 13, an image generator 14 and a projection lens set 15. The light source 10 generates a beam of light. The beam passes through the color wheel 11, the optical channel 12, and the lens set 13, projecting onto the image generator 14. The image generator 14 can be a digital micro-mirror device (DMD) having several micro-mirrors. The beam reflected from the image generator 14 then transmitted into the projection lens set 15. The projection lens set 15 has several lenses and a reflector disposed inside a lens cylinder (not shown). The reflector bends the beam and changes its optical pathway. The beam is then magnified by the lenses and projected onto a screen 16 to form an image.

To improve the contrast of the projected image, the micro-mirrors rotate infinitesimally to result in slight difference in the optical fluxes. However, the variations in the micro-mirrors are limited. As shown in FIG. 2, the projection system 1 further includes an optical shutter 17 in the vicinity of the projection lens set 15. The swinging of the optical shutter 17 generates differences in the optical fluxes so that the contrast can be increased.

As shown in FIG. 2, a conventional optical shutter 17 is disposed in the vicinity of the projection lens set 15. The optical shutter 17 includes a shutter element 18 and an actuator 19. The shutter element 18 has a light-shielding plate 181. The actuator 19 includes a coil 191 and a magnetic element 192. The coil 191 is wound around the base of the light-shielding plate 181. The magnetic element 192 is disposed corresponding to the coil 191. When the coil 191 is provided with a current, a magnetic field perpendicular to the light-shielding plate 181 is produced. The light-shielding plate 181 swings under the interaction with the magnetic element 192. The use of the light-shielding plate 181 increases the contrast of the images projected on the screen 16 up to 5000:1, largely improving the image quality.

However, the light-shielding plate 181 of the conventional optical shutter 17 is perpendicular to the rotating axis X. Therefore, the light-shielding plate 181 has a larger distance from the rotating axis X and, with the same mass, has a large rotational inertia. Therefore, the response speed is slow. Besides, the structure of the optical shutter 17 is also a limitation to the spatial configuration of the projection system 1 that is not suitable for miniaturization.

Therefore, it is an important subject to provide an optical shutter with a smaller rotational inertia and versatility in the spatial configuration of the projection system.

### SUMMARY OF THE INVENTION

In view of the foregoing, the invention is to provide an optical shutter that has a smaller rotational inertia and reduces the limitation in the spatial configuration of the projection system.

To achieve the above, the invention discloses an optical shutter including a shutter element and an actuator. The shutter element includes a light-shielding portion and a linkage portion connected with each other. The light-shielding portion faces the linkage portion and forms a predetermined angle. The light-shielding portion and the linkage portion are arranged in a predetermined angle. The actuator couples to the linkage portion to drive the shutter element to swing.

To achieve the above, an optical shutter of the invention is disposed in the vicinity of the projection lens set in a projection system. The projection lens set includes a lens cylinder which accommodates several lenses. The optical shutter is connected to the lens cylinder. The optical shutter includes a shutter element and an actuator. The shutter element has a light-shielding portion and a linkage portion. The light-shielding portion is connected to the linkage portion. The light-shielding portion faces the linkage portion and forms a predetermined angle. The actuator couples to the linkage portion to drive the shutter element to swing.

As mentioned above, the optical shutter and the projection system of the invention have the light-shielding portion of the shutter element bent by a predetermined angle toward the linkage portion. The distance between the optical shutter and the rotating axis of the shutter element is thus shorter. Therefore, as the same mass, the shutter element has a smaller rotational inertia and thus a faster response speed. Compared with the conventional optical shutter, the shutter element of the invention is bent by a predetermined angle. When it is combined with the projection lens set, the entire size is smaller while achieving the light-shielding effect and increasing the image contrast. The versatility of the optical shutter of the invention in spatial configuration is increased to satisfy the trend of compactifying the projection system.

### BRIEF DESCRIPTION OF THE DRAWINGS

The invention will become more fully understood from the subsequent detailed description and the accompanying drawings, which are given by way of illustration only, and thus are not limitative of the present invention, and wherein:

FIG. 1 is a schematic view of the conventional optical projection system;

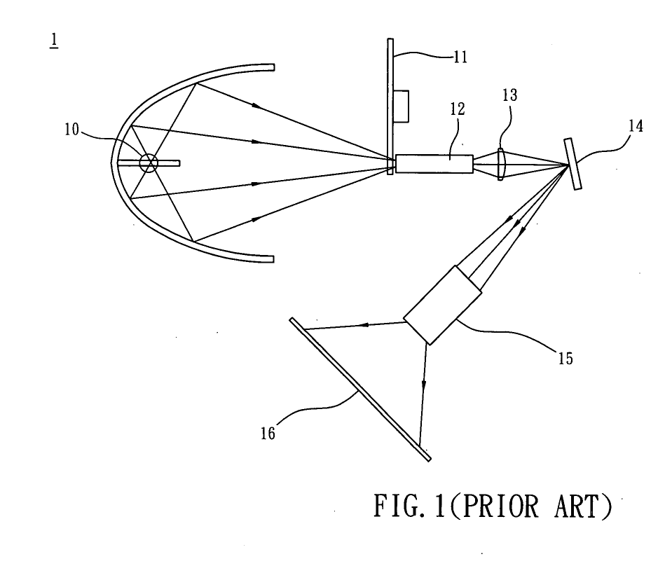

FIG. 2 is a fragmentary sectional view of the conventional projection lens set and optical shutter;

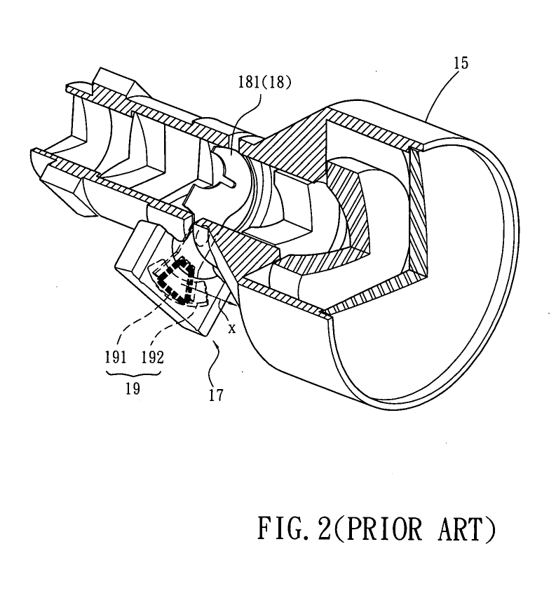

FIG. 3 is a schematic view of an embodiment of the optical shutter according to the invention;

FIG. 4 is a side view of the optical shutter shown in FIG. 3;

FIG. 5 is a fragmentary sectional view of a optical shutter connected with the lens cylinder according to the invention; and

FIG. 6 is a schematic view of an embodiment of the projection system according to the invention.

### DETAILED DESCRIPTION OF THE INVENTION

The present invention will be apparent from the following detailed description, which proceeds with reference to the accompanying drawings, wherein the same references relate to the same elements.

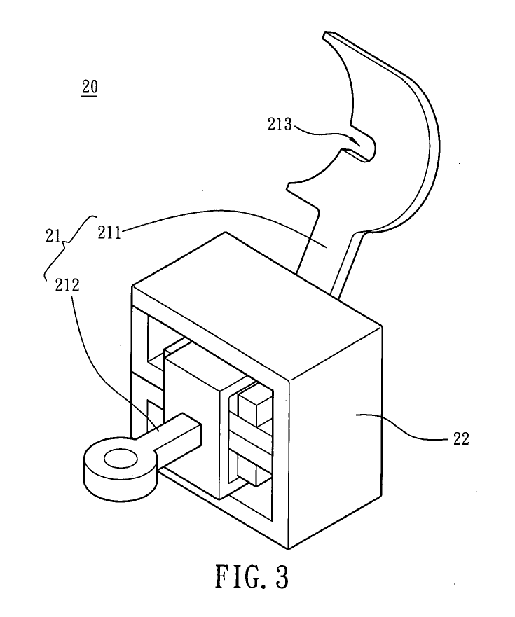

As shown in FIG. 3, the optical shutter 20 according to the invention includes a shutter element 21 and an actuator 22. The optical shutter 20 can be used in a projection system.

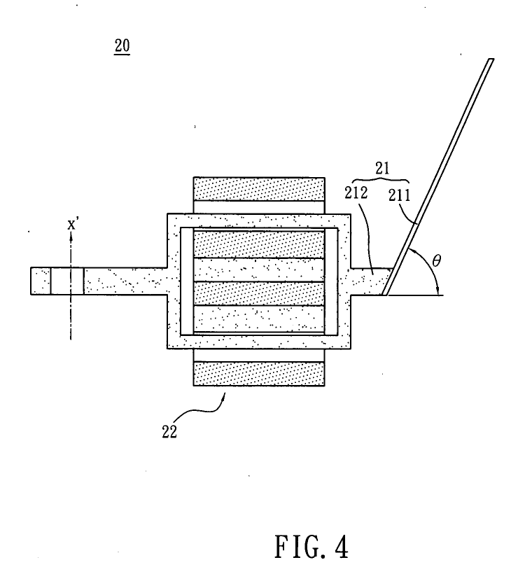

As shown in FIGS. 3 and 4, the shutter element 21 includes a light-shielding portion 211 and a linkage portion 212 connected with each other. The light-shielding portion 211 faces the linkage portion 212 and bends toward the linkage portion 212 to form a predetermined outer angle θ (FIG. 4). In this embodiment, the outer angle is preferably smaller than or equal to 90 degrees. That is, the light-shielding portion 211 is not parallel to the linkage portion 212 and the angle between them is θ. Here the angle between the light-shielding portion 211 and a rotating axis X′ is equal to (90−θ), thus effectively reducing the rotational inertia. For example, when the outer angle is equal to 90, the light-shielding portion 211 is perpendicular to the linkage portion 212 and parallel to the rotating axis X′.

The light-shielding portion 211 is made of an opaque material, such as but not limited to plastic or metal. The light-shielding portion 211 has a notch 213. As shown in FIG. 3, the notch 213 is semi-circular, but not limited to this shape. The shape of the notch 213 can be modified according to the light-shielding efficiency of the projection system.

In this embodiment, the actuator 22 is a magnetic actuator. It includes at least a coil and a magnetic element (not shown). The magnetic element (e.g., a permanent magnet) is disposed corresponding to the coil. The coil is wound around the linkage portion 212. The coil is provided with an electrical current to produce a magnetic field. The interaction between the magnetic field and the magnetic element drives the shutter element 21 to swing. The relation between the coil and the magnetic element is not limited to the example disclosed herein. The magnetic element can be disposed on the linkage portion 212, and the coil is disposed corresponding to the magnetic element. Such a configuration also achieves the goal of driving the shutter element 21.

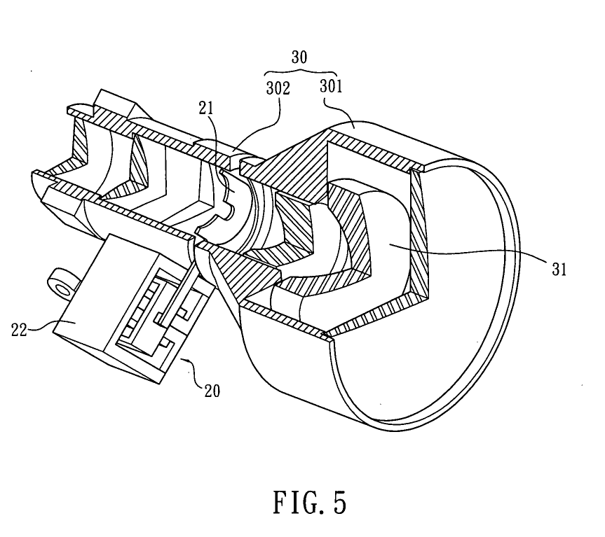

As shown in FIG. 5, the optical shutter 20 according to an embodiment of the invention is connected to a lens cylinder 30.

As shown in FIG. 5, the lens cylinder 30 includes a lens assembly 301 and a cylinder 302. The cylinder 302 is connected to one end of the lens assembly 301. Several lenses 31 are accommodated inside the lens cylinder 30.

The optical shutter 20 is connected to the lens cylinder 30 so that the shutter element 21 is on the optical pathway of the projection system. The action of the optical shutter 20 controls the optical fluxes in the projection system to efficiently improving the projected image and increasing its contrast.

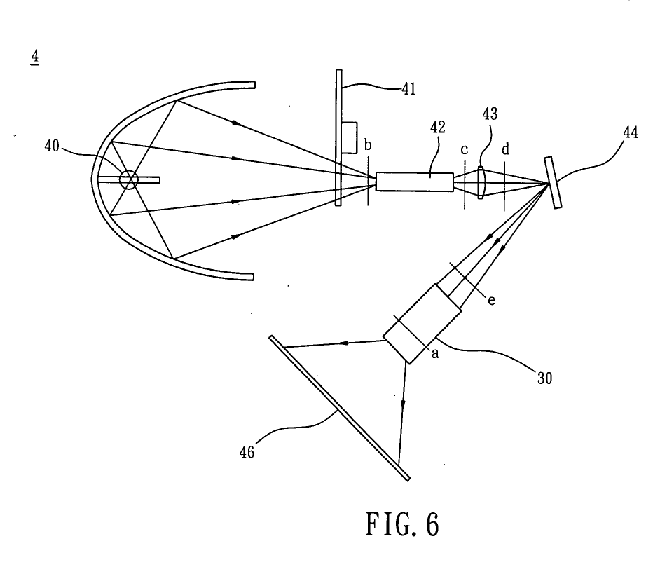

As shown in FIG. 6, the optical shutter 20 is used in a projection system 4. Besides connecting with the lens cylinder 30 (indicated by “a” in FIG. 6), the optical shutter 20 in the projection system 4 can also be disposed at any arbitrary position on the optical pathway. For example, the optical shutter 20 can be disposed at a position after the beam passes through the color wheel 41 (“b” in FIG. 6), after the beam passes through the optical channel 42 (“c” in FIG. 6), or before or after the reflection by the image generator 44 (“d” and “e” in FIG. 6). All such positions are acceptable as long as the optical shutter 20 can result in differences in the optical fluxes and an increase in contrast of the image.

In summary, the optical shutter and projection system of the invention have the light-shielding portion of the shutter element bent by a predetermined angle toward the linkage portion. The distance between the optical shutter and the rotating axis of the shutter element is thus shorter. Therefore, for the same mass, the shutter element has a smaller rotational inertia and thus a faster response speed. Compared with the prior art, the shutter element of the invention is bent by a predetermined angle. When it is combined with the projection lens set, the entire size is smaller while. Therefore, the versatility in spatial configuration is increased to satisfy the trend of compactifying the projection system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical shutter comprising:
a shutter element having a light-shielding portion and a linkage portion connected to the light-shielding portion, wherein the light-shielding portion is bent toward the linkage portion by a predetermined angle; and
an actuator coupled to the linkage portion for driving the light-shielding element.

2. The optical shutter as recited in claim 1, wherein the predetermined angle is the outer angle between the light-shielding portion and the linkage portion and is smaller than or equal to 90 degrees.

3. The optical shutter as recited in claim 1, wherein the actuator is a magnetic actuator having at least one coil and one magnetic element disposed corresponding to the coil.

4. The optical shutter as recited in claim 3, wherein the coil is wound around the linkage portion and the magnetic element is disposed at the linkage portion.

5. The optical shutter as recited in claim 1, wherein the light-shielding portion of the shutter element has a notch.

6. The optical shutter as recited in claim 5, wherein the notch is semi-circular.

7. A projection system comprising:
a light source;
a color wheel;
an optical channel;
a lens set;
an image generator; and
a projection lens set having an optical shutter, the optical shutter comprising:
a shutter element having a light-shielding portion and a linkage portion connected with the light-shielding portion, wherein the light-shielding portion and is bent toward the linkage portion by a predetermined angle, and
an actuator coupled to the linkage portion for driving the shutter element, wherein the light source produces a beam passing through the color wheel, the optical channel, and the lens set and entering the image generator, and the image generator projects the beam to form an image via the projection lens set.

8. The projection system as recited in claim 7, wherein the predetermined angle is the outer angle between the light-shielding portion and the linkage portion and is smaller than or equal to 90 degrees.

9. The projection system as recited in claim 7, wherein the actuator is a magnetic actuator having at least one coil and one magnetic element disposed corresponding to the coil.

10. The projection system as recited in claim 9, wherein the coil is wound around the linkage portion and the magnetic element is disposed at the linkage portion.

11. The projection system as recited in claim 7, wherein the light-shielding portion of the shutter element has a notch.

12. A projection system having a light source, a color wheel, an optical channel, at least one lens set, an image generator, and a projection lens set, wherein a beam generated by the light source passes through the color wheel, the optical channel and the lens set, is reflected by the image generator, and projects onto a screen via the projection lens set, and the optical flux of the beam emitted by the light source is controlled by a optical shutter, the optical shutter comprising:
a shutter element having a light-shielding portion and a linkage portion connected with the light-shielding portion, wherein the light-shielding portion and is bent toward the linkage portion by a predetermined angle; and
an actuator coupled to the linkage portion for driving the shutter element.

13. The projection system as recited in claim 12, wherein the optical shutter is disposed at a position after the beam passes through the color wheel.

14. The projection system as recited in claim 12, wherein the optical shutter is disposed at a position after the beam passes through the optical channel.

15. The projection system as recited in claim 12, wherein the optical shutter is disposed at a position before the beam passes through the image generator.

16. The projection system as recited in claim 12, wherein the optical shutter is disposed at a position after the beam passes through the image generator.

17. The projection system as recited in claim 12, wherein the predetermined angle is the outer angle between the light-shielding portion and the linkage portion and is smaller than or equal to 90 degrees.

18. The projection system as recited in claim 12, wherein the actuator is a magnetic actuator having at least one coil and one magnetic element disposed corresponding to the coil.

19. The projection system as recited in claim 12, wherein the coil is wound around the linkage portion and the magnetic element is disposed at the linkage portion.

20. The projection system as recited in claim 12, wherein the light-shielding portion of the shutter element has a notch.
